(19) United States
(12) Patent Application Publication
(10) Pub. No.: US 2020/0339835 A1
(43) Pub. Date: Oct. 29, 2020

(54) POLYURETHANE COATING WITH A HIGH BIOSOURCED MONOMER CONTENT, COMPRISING ISOSORBIDE AND PENTAMETHYLENE DIISOCYANATE

(71) Applicant: ROQUETTE FRERES, Lestrem (FR)

(72) Inventors: Nicolas JACQUEL, LAMBERSART (FR); René SAINT-LOUP, LOMME (FR); Jean-Pierre PASCAULT, VILLEURBANNE (FR); Héloïse BLACHE, CANTELEU (FR); Alain ROUSSEAU, SAINT-PRIEST (FR); Françoise MECHIN, LYON (FR); Etienne FLEURY, SOUCIEU EN JARREST (FR)

(21) Appl. No.: 16/759,123

(22) PCT Filed: Oct. 26, 2018
(86) PCT No.: PCT/FR2018/052665

§ 371 Date: Apr. 24, 2020

(30) Foreign Application Priority Data
Oct. 27, 2017 (FR) 17 60156

(51) Int. Cl. C09D 175/08; C08G 18/08; C08G 18/32; C08G 18/48; C08G 18/72; C08G 18/75; C08G 18/79

(52) U.S. Cl. CPC C09D 175/08; C08G 18/0852; C08G 18/3218; C08G 2150/00; C08G 18/725; C08G 18/755; C08G 18/792; C08G 18/4854

(57) ABSTRACT

The present invention relates to a crosslinkable composition for forming a polyurethane coating on different types of substrates. The present invention relates in particular to a polyurethane composition with a high biosourced monomer content, comprising isosorbide as a diol chain extender and a pentamethylene diisocyanate trimer; the invention also relates to the polyurethane coating obtained from this composition.

### TECHNICAL FIELD OF THE INVENTION

The present invention relates to a crosslinkable composition for forming a polyurethane coating on different types of substrates. The present invention relates in particular to a polyurethane composition with a high content of biobased monomers comprising isosorbide as chain-extender diol and a pentamethylene diisocyanate trimer and to the polyurethane coating obtained from this composition.

### PRIOR ART

Many industries require compositions for forming coatings on substrates. They may, for example, be protective, decorative or surface-treatment coatings.

The great versatility of polyurethanes make them a material of choice for coatings. With a very wide hardness range, very good impact resistance and resistance to cracking and very good chemical resistance, they are suitable for coating all types of surfaces.

A crosslinked polyurethane coating is conventionally obtained by reaction of a long-chain polyol, a short-chain diol and a polyisocyanate. Various compounds are described in the literature for each of these reagents. In general, at least one of the two mixtures, either the mixture of polyols or the mixture of polyisocyanates, has a functionality strictly greater than two in order to obtain a network. The amount of compounds with functionality greater than or equal to 2 makes it possible to adapt the crosslinking density and is therefore one of the solutions for adapting the properties of the network.

The polyisocyanate is generally an aliphatic polyisocyanate or a mixture of aliphatic polyisocyanates having an —NCO functionality strictly greater than 2 when used with polyols having average functionality equal to two. Indeed, compared to aromatic polyisocyanates, aliphatic polyisocyanates make it possible to obtain coatings which advantageously resist yellowing when exposed to light. The —NCO functionality strictly greater than 2 makes it possible to obtain a crosslinked polyurethane.

The long-chain polyol is generally a polyether polyol diol or a polyester polyol or a polycarbonate polyol which can in particular have a molecular weight of 400 to 4000 g/mol. The short-chain diol, also called chain-extender diol, is usually 1,4-butanediol.

The long-chain polyol gives flexibility to the polyurethane coating. The short-chain diol contributes, with the polyisocyanate, to the hardness of the coating.

A polyurethane coating conventionally has a single glass transition temperature (Tg). Indeed, a coating obtained with a material exhibiting phase segregation would have a white coloration linked to the heterogeneity of the material, these different phases resulting in optical phenomena which make the material opaque. The Tg of a polyurethane coating is greater than or equal to 30° C. so as not to give it tackiness under the usual conditions of use.

There is a need for new crosslinked polyurethane coatings which have good mechanical properties, good adhesion to the substrate and high stability over time.

The applicant has discovered that the use of isosorbide and of pentamethylene diisocyanate trimer makes it possible to improve the properties of the polyurethane coating obtained, in particular the adhesion to the substrate, the impact resistance and the resistance to folding. Furthermore, the use of isosorbide makes it possible to increase the Tg and the rigidity of the coating compared to the same coating obtained with BDO.

The polyurethane coating obtained with the composition of the present invention also has the advantage of having a high content of biobased monomers since the isosorbide is a fully biobased product and the pentamethylene diisocyanate trimer is a product partially derived from biobased material. Indeed, in the current context of the gradual reduction of petroleum-product resources, it is increasingly advantageous to replace products of petroleum origin with products of natural origin.

In addition, the pentamethylene diisocyanate trimer exhibits lower volatility than diisocyanate monomers. Thus, its handling is less risky and the replacement of diisocyanate monomers with a pentamethylene diisocyanate trimer will reduce the toxicity of a non-crosslinked polyurethane composition.

### SUMMARY OF THE INVENTION

A subject of the invention is thus a composition comprising:
a polyol fraction comprising a polyol chosen from a polyester polyol, a polyether polyol, a polycarbonate polyol or a mixture thereof, said polyol being a diol or a mixture of diols;
a polyisocyanate fraction comprising a pentamethylene diisocyanate trimer;
isosorbide.

Another object of the invention is a process for producing a polyurethane coating on a substrate, which comprises the following steps:
depositing on the substrate a layer of the composition according to the invention, then
crosslinking the composition.

Another subject of the invention is a polyurethane coating that can be obtained by means of the process according to the invention.

### DETAILED DESCRIPTION

In the following description, the expression “between . . . and . . . ” should be interpreted as including the limits of the range described.

### Polyurethane Coating Composition

The present invention relates to a crosslinkable polyurethane coating composition.

For the purposes of the present invention, the term “crosslinkable polyurethane coating composition” is intended to mean a composition capable of providing a polyurethane coating after crosslinking of the composition.

For the purposes of the present invention, the term “polyurethane coating” is intended to mean a crosslinked polyurethane deposited on a solid substrate in the form of a thin layer, for example a layer with a thickness of 20 to 500 micrometers, in particular 20 μm , 50 μm, 100 μm, 150 μm, 200 μm, 250 μm, 300 μm, 350 μm, 400 μm or 450 μm. The coatings may, for example, be protective, decorative or surface-treatment coatings. Protective films, varnishes and paints are among the coatings for the purposes of the present invention.

For the purposes of the present invention, the term “crosslinking” is intended to mean the formation of one or more three-dimensional networks by creation of chemical bonds between the polymer chains. A polymer can be crosslinked when it comprises a monomer unit having more than 2 reactive functions in polymerization. Thus, the crosslinked polyurethane of the invention is obtained by introducing a pentamethylene diisocyanate trimer into the polyurethane coating composition. Crosslinking can in particular be carried out under the action of heat or by irradiation with a UV beam, optionally in the presence of a catalyst.

The crosslinkable polyurethane coating composition according to the invention differs from a thermoplastic polyurethane (TPU) composition and from an adhesive composition based on polyurethane.

Thus, the polyurethane coating obtained by crosslinking the composition according to the invention has a single glass transition temperature (Tg), said Tg being greater than or equal to 20° C., preferably greater than or equal to 25° C., more preferentially greater than or equal to 30° C. The Tg of the polyurethane coating obtained by crosslinking the composition according to the invention can in particular be measured by dynamic mechanical analysis or by differential scanning calorimetry.

Isosorbide

The composition according to the invention comprises isosorbide. The isosorbide is used as a chain-extender diol.

Isosorbide is a cycloaliphatic diol corresponding to the formula:

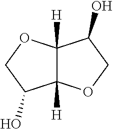

The term “isosorbide” as used in the present application encompasses all the stereoisomers (i.e. the enantiomers or diastereoisomers) of isosorbide, that is to say, inter alia, isoidide and isomannide.

### Polyol fraction

The composition according to the invention comprises a polyol fraction.

The polyol fraction comprises or consists of a polyol or a mixture of polyols.

For the purposes of the present invention, the term “polyol” is intended to mean a compound having an —OH functionality greater than or equal to 2. The term polyol therefore includes diols and triols. For the purposes of the present invention, isosorbide is not considered to be a polyol.

For the purposes of the present invention, the term “—OH functionality” is intended to mean the total number of reactive hydroxyl functions per molecule of compound. The —OH functionality (f_{OH}) can be calculated from the hydroxyl number (HN) and the number-average molar mass of the polyol (Mn_{polyol}) according to the following formula:

f_{OH}=(HN×Mn_{polyol})/56 100

The hydroxyl number can be measured by acetylation followed by back titration with potassium hydroxide according to standard ISO 14900: 2001, Plastics—Polyols for the production of polyurethane—Determination of the hydroxyl number. The hydroxyl number is expressed in mg KOH/g which corresponds to the amount of KOH in mg which is necessary to neutralize 1 g of polyol.

The polyol fraction comprises or consists of a diol or a mixture of diols.

The polyol fraction can also comprise a triol.

According to one particular embodiment, the polyol fraction comprises or consists of a mixture of diols and triols.

The polyol of the polyol fraction may in particular have a molecular weight of between 400 and 4000 g/mol, preferably between 500 and 200 g/mol and more preferentially between 600 and 1500 g/mol.

The polyol of the polyol fraction is a polyester polyol or a polyether polyol or a polycarbonate polyol. The polyester polyol, the polyether polyol and the polycarbonate polyol are preferably linear polyols which may contain aliphatic, alicyclic or heterocyclic monomer units.

For the purposes of the present invention, the term “linear polyol” is intended to mean a polyol which does not comprise a side chain having a reactive function for polymerization.

The polyether polyol, also called polyalkylene ether polyol, is preferably a linear polyether having two end hydroxyl functions. The alkylene portion can comprise 2 to 10 carbon atoms, preferably 2 to 4 carbon atoms. It can in particular be obtained by opening a cyclic ether, such as an epoxide, with a glycol. The polyether polyols according to the present invention comprise block or random copolyether glycols, in particular block or random copolymers of ethylene oxide and of propylene oxide. Examples of polyether polyols according to the present invention are a polyethylene glycol (PEG), a polypropylene glycol (PPG), a poly(oxyethylene-oxypropylene) glycol, a polytetramethylene ether glycol (PTMEG) or a mixture thereof.

The polyester polyol is preferably a linear polyester having two end hydroxyl functions. It can be obtained by linear condensation of at least one glycol with at least one dicarboxylic acid or by reaction of a cyclic ester with a glycol. The polyester polyols according to the present invention comprise block or random copolyester glycols; such copolyester polyols may in particular be obtained by the use of a mixture of at least two glycols and/or at least two dicarboxylic acids. The glycols used may comprise 2 to 8 carbon atoms, preferably 2 to 6 carbon atoms, such as ethylene glycol, propylene glycol, 1,3-propanediol, butylene glycol, 1,4-butane and 1,6-hexanediol. The dicarboxylic acids used generally have 4 to 10 carbon atoms, such as succinic acid, glutamic acid, glutaric acid, octanedioic acid, sebacic acid, maleic acid, fumaric acid, adipic acid, azelaic acid, phthalic acid, isophthalic acid and terephthalic acid. The dicarboxylic acid used may be a dicarboxylic fatty acid, that is to say a saturated or unsaturated aliphatic dicarboxylic acid comprising from 8 to 44 atoms between the acid functions, possibly being synthesized for example by dimerization of unsaturated aliphatic monocarboxylic acids or unsaturated aliphatic esters having between 8 and 22 carbon atoms such as linoleic and linolenic acid. The cyclic ester used is generally epsilon-caprolactone. Examples of polyester polyols according to the present invention are hydroxytelechelic polyesters of poly(ethylene adipate), poly (propylene adipate), poly(propylene-co-ethylene adipate), poly(butylene adipate), poly(ethylene-co-butylene adipate), or poly(caprolactone) diol type, copolymers of caprolactone and of lactide, or a mixture thereof.

The polycarbonate polyol is preferably a linear polycarbonate having two end hydroxyl functions. It can be obtained by linear condensation of at least one glycol with at least one phosgene or alkyl carbonate derivative. It can also be obtained by reaction between propylene oxide and CO₂. The polycarbonate polyols according to the present invention comprise block or random copolycarbonate glycols; such copolycarbonate polyols can in particular be obtained by using a mixture of at least two glycols and of alkyl carbonate. The diols can be linear aliphatic diols, cyclic diols or heterocyclic diols.

According to one preferred embodiment, the polyol fraction comprises a polyol chosen from a polyethylene glycol (PEG), a polypropylene glycol (PPG), a polytetramethylene ether glycol (PTMEG), a poly(caprolactone) diol or a mixture thereof; preferably a PTMEG; more preferentially a PTMEG having a molecular weight of 250 to 4000, preferably 400 to 2000 g/mol.

The amount of polyol relative to the amount of isosorbide is adjusted in order to obtain a molar ratio of all the —OH functions of the polyol fraction to all the —OH functions of the isosorbide of between 0.2 and 2, preferably of between 0.3 and 1, more preferentially of between 0.4 and 0.6.

### Polyisocyanate Fraction

The composition according to the invention comprises a polyisocyanate fraction.

The polyisocyanate fraction comprises or consists of a polyisocyanate or a mixture of polyisocyanates.

For the purposes of the present invention, the term “polyisocyanate” is intended to mean a compound having an —NCO functionality greater than or equal to 2. The term polyisocyanate therefore in particular includes diisocyanates having an —NCO functionality equal to 2, triisocyanates having an —NCO functionality equal to 3, and also polyisocyanates having an —NCO functionality strictly greater than 2 and strictly less than 3.

For the purposes of the present invention, the term “—NCO functionality” is intended to mean the total number of reactive isocyanate functions per molecule of compound. The —NCO functionality can be estimated by calculation after NCO back titration of excess dibutylamine with hydrochloric acid (according to standard EN ISO 14896-2006).

The polyisocyanate fraction comprises a pentamethylene diisocyanate trimer.

The polyisocyanate fraction of the composition according to the invention can also comprise an aliphatic diisocyanate.

For the purposes of the present invention, the term “aliphatic diisocyanate” is intended to mean a diisocyanate which does not contain an aromatic ring. The term aliphatic diisocyanate therefore includes non-cyclic aliphatic diisocyanates and cycloaliphatic diisocyanates.

Preferably, the aliphatic diisocyanate is chosen from pentamethylene diisocyanate (PMDI), hexamethylene diisocyanate (HDI), isophorone diisocyanate (IPDI), methylene dicyclohexyl diisocyanate (HMDI or hydrogenated MDI) or a mixture thereof; more preferentially IPDI.

The polyisocyanate fraction may in particular comprise at least 5 mol % relative to the —NCO functions, in particular at least 10 mol % relative to the —NCO functions, more particularly at least 15 mol % relative to the —NCO functions, of pentamethylene diisocyanate trimer.

According to one particular embodiment, the polyisocyanate fraction of the composition according to the invention comprises:
1 to 40 mol %, preferably 2 to 30 mol %, relative to the —NCO functions of pentamethylene diisocyanate trimer; and
60 to 99 mol %, preferably 70 to 98 mol %, relative to the —NCO functions of aliphatic diisocyanate.

The total amount of polyisocyanate relative to the amount of isosorbide and of polyol is adjusted in order to obtain a molar ratio of all the —OH functions of the polyol fraction and of the isosorbide to all the —NCO functions of the polyisocyanate fraction of between 0.8 and 1.2, preferably of between 0.95 and 1.05.

### Catalyst

The composition according to the invention can also comprise a catalyst. The catalyst makes it possible to accelerate the polymerization reaction and/or to increase the degree of polymerization of the polyurethane.

Examples of a catalyst that can be introduced into the composition are organic or inorganic acid salts; organometallic derivatives of bismuth, of lead, of tin, of antimony, of uranium, of cadmium, of cobalt, of thorium, of aluminum, of mercury, of zinc, of nickel, of cerium, of molybdenum, of vanadium, of copper, of manganese or of zirconium; phosphines; organic tertiary amines; or a mixture thereof. Preferably, the catalyst is dibutyltin dilaurate.

According to one particular embodiment, the amount of catalyst is between 0.001 and 5%, preferably between 0.005 and 1.0% by weight relative to the total weight of the polyol fraction, of the polyisocyanate fraction and of the isosorbide.

### Solvent

The composition according to the invention can also comprise a solvent.

Examples of solvents which can be introduced into the composition are ketones, hydrocarbon-based solvents, ethers, esters, nitriles, sulfones, dimethyl sulfoxide, aromatic compounds or a mixture thereof. Preferably, the solvent is chosen from 2-butanone, cyclopentanone, dimethyl isosorbide (DMI) or a mixture thereof, more preferably a mixture of 2-butanone and DMI.

According to one particular embodiment, the amount of solvent is between 10 and 60%, preferably between 20 and 50% by weight relative to the total weight of the formulation.

### Additives

The composition according to the invention can also comprise a spreading agent. The spreading agent makes it possible to obtain, before crosslinking, good spreading of the composition when it is applied to the substrate. The spreading agent can be particularly useful in preventing the formation of craters in the coating by lowering the surface tension of the composition.

An example of a spreading agent that can be introduced into the composition according to the invention is a polyether-modified polydimethylsiloxane such as BYK 307 sold by BYK.

The amount of spreading agent in the composition is from 0.01 to 0.2%, preferably 0.05 to 0.15%, by weight relative to the total weight of the polyol fraction, of the polyisocyanate fraction and of the isosorbide.

The composition according to the invention can also comprise other additives, for example polymerization inhibitors, dyes, pigments, opacifiers, thermal or ultraviolet protection additives, antistatic agents, antibacterial agents, antisoiling agents or antifungals.

Preferably, the composition according to the invention comprises less than 10%, more preferentially less than 2% by weight of these additives, relative to the weight of the composition.

### Process for Producing the Crosslinkable Polyurethane Coating Composition

The composition according to the invention can be prepared by mixing the ingredients which constitute it, in particular with stirring. The amount of solvent makes it possible to adjust the viscosity of the composition.

Process for producing the polyurethane coating The process for producing the polyurethane coating according to the invention comprises a step of depositing on a solid substrate a layer of the composition as described above.

The composition can be deposited using any means known to those skilled in the art, for example by dip-coating, by centrifugal coating, by “barcoater”, by “tape casting”, by spraying or using a brush or a roller. The thickness of the layer deposited is adjusted according to the thickness of the coating that it is desired to obtain. The thickness of the deposited layer may, for example, be between 100 nm and 2 mm, preferably from 100 to 500 micrometers. Preferably, the layer has a uniform thickness, so as to obtain a uniform final coating.

The substrate on which the coating is applied can be of any kind. These substrates may in particular be wood, metal, plastic, glass or paper substrates.

The process according to the invention also comprises a step of crosslinking the composition.

The crosslinking of the composition can in particular be carried out by heating. According to one particular embodiment, the heating is carried out at a temperature ranging from 100° C. to 250° C., preferentially from 150° C. to 200° C. In particular, the temperature can be increased in temperature steps or else by using a temperature gradient.

The duration of the heating can in particular be between 1 h and 5 h, preferably between 1 h 30 and 3 h.

The heating can also be carried out under vacuum.

The process according to the invention makes it possible to obtain a polyurethane coating which has advantageous properties. In particular, the coatings obtained can have at least one of the following properties:
good transparency;
a low refractive index;
high gloss;
good adhesion to the substrate;
high hardness;
good resistance to abrasion or wear;
good chemical resistance, to solvents, for example to water, or good water resistance, but also good resistance to bases and acids;
good impact resistance/impact strength; and
good deformation resistance.

The coatings obtained which are also subjects of the present invention have properties that are at least as good, if not better, than currently available coatings obtained with 1,4-butanediol as the chain-extender diol.

The invention will be understood more clearly in the light of the nonlimiting and purely illustrative examples which follow.

### EXAMPLES

### A. Preparation of Crosslinkable Compositions in Accordance (EX) or Not in Accordance With the Invention (CEX)

The following products were used in the examples:
polyol: poly(tetramethylene glycol) of molecular weight 650 g/mol (PTMEG 650) or 1000 g/mol (PTMEG 1000) (Sigma-Aldrich)
polyisocyanate: pentamethylene diisocyanate trimer (t-PMDI) (Covestro)
diisocyanate: isophorone diisocyanate (IPDI) (Aldrich)
chain-extender diol: isosorbide (Roquette) or 1,4-butanediol (BDO) (Sigma Aldrich)
solvent: 2-butanone and dimethyl isosorbide (Roquette)
additive: polyether-modified polydimethylsiloxane (BYK 307) (BYK)
catalyst: dibutyltin dilaurate (DBTDL) (Sigma Aldrich)

Various compositions were prepared by mixing the monomers indicated in the table below with a (—OH polyol)/(—NCO polyisocyanate+diisocyanate)/(—OH chain extender) stoichiometry of 1/3.05/2. The monomers (that is to say the polyol, the diisocyanate, the polyisocyanate and the chain extender) are introduced into a solvent mixture comprising 2-butanone and dimethyl isosorbide (volume ratio 1:5) to obtain a concentration of 70% by weight of the monomers relative to the weight of the composition. The BYK 307 additive is added, to reduce the crater effects, at a percentage of 0.1% by weight relative to the weight of the monomers. The DBTDL catalyst is added at a percentage of 0.025% by weight relative to the weight of the monomers in order to accelerate the reaction (except for the CEX1 formulation which gelled before application).

| | MONOMERS | | | |
|---|---|---|---|---|
| | | Diisocyanate | Polyisocyanate | Chain- |
| | | (mol % of NCO | (mol % of NCO | extender |
| | Polyol | functions) | functions) | diol |
| EX1 | PTMEG 650 | — | t-PMDI (100%) | Isosorbide |
| EX2 | PTMEG 650 | IPDI (80%) | t-PMDI (20%) | Isosorbide |
| CEX1 | PTMEG 650 | — | t-PMDI (100% | BDO |
| CEX2 | PTMEG 650 | IPDI (80%) | t-PMDI (20%) | BDO |

### B. Production of the Coatings on a Steel Support

A thin layer of crosslinkable composition as described above was deposited on steel plates (Q-panel R44 standardized) using a Sheen Instruments 1133N bar-coater, equipped with a 150 μm bar in order to cover the entire surface of the support with the minimum of composition.

The composition is then crosslinked in a vacuum oven under a vacuum of 100 mbar according to the following thermal cycle:
heating at 100° C. for 60 min;
increase in the heating temperature from 100° C. to 140° C. with a gradient of 2° C./min;
heating at 140° C. for 90 min;
increase in the heating temperature from 140° C. to 160° C. with a gradient of 2° C./min;
heating at 160° C. for 30 min.

### C. Characterization/Evaluation of the Properties of the Coatings Thus Obtained

### Impact Resistance (1 kg at 1 m)

The impact resistance measurements were carried out according to standard ISO 6272: Paints and varnishes—Rapid deformation (impact resistance)tests—Part 1: falling-weight test, large area indenter.

### Adhesion (Grid Test)

The adhesion measurements were carried out in accordance with ISO standard 2409 “Paints and varnishes—Cross-cut test”.

Folding

The folding tests were carried out by folding the support at 90° (coating on the inside and outside face). The resistance of the coating was then evaluated qualitatively at the level of the fold.

### Glass Transition Temperature (Tg)

The Tg measurements (expressed in degrees Celsius (° C.)) were carried out by differential scanning calorimetry (measured at the second pass −60° C. to 250° C., 20° C.min⁻¹.

| | | | | | Tg |
|---|---|---|---|---|---|
| | Impact resistance | Adhesion | | Folding | (° C.) |
| EX1 | Good | + | (1) | OK | 30 |
| EX2 | Good | ++ | (0) | OK | 48 |
| CEX1 | Poor | −− | (4) | Tearing | 4 |
| CEX2 | Good | + | (1) | OK | 14 |

The tests show that the coatings obtained after crosslinking of compositions containing isosorbide and pentamethylene diisocyanate have a higher Tg than the corresponding coatings obtained with BDO. In addition, the replacement of BDO with isosorbide can also lead to an increase in the adhesion of the coating to the substrate and to an increase in its folding resistance (cf. EX2 compared to CEX2).

1. A crosslinkable polyurethane coating composition comprising:
a polyol fraction comprising a polyol chosen from a polyester polyol, a polyether polyol, a polycarbonate polyol or a mixture thereof, said polyol being a diol or a mixture of diols;
a polyisocyanate fraction comprising a pentamethylene diisocyanate trimer;
isosorbide.

2. The composition as claimed in claim 1, wherein the polyurethane coating obtained by crosslinking the composition has a single glass transition temperature Tg, said Tg being greater than or equal to 20° C., preferably greater than or equal to 25° C., more preferentially greater than or equal to 30° C.

3. The composition as claimed in claim 1, wherein the molar ratio of all the —OH functions of the polyol fraction and of the isosorbide to all of the —NCO functions of the polyisocyanate fraction is between 0.8 and 1.2, preferably between 0.95 and 1.05.

4. The composition as claimed in claim 1, wherein the molar ratio of all the —OH functions of the polyol fraction to all the —OH functions of the isosorbide is between 0.2 and 2; preferably between 0.3 and 1, more preferentially between 0.4 and 0.6.

5. The composition as claimed in claim 1, wherein the polyol has a molecular weight of between 400 and 4000 g/mol, preferably between 500 and 2000 g/mol and more preferentially between 600 and 1500 g/mol.

6. The composition as claimed in claim 1, wherein the polyol is chosen from a polyethylene glycol (PEG), a polypropylene glycol (PPG), a polytetramethylene ether glycol (PTMEG), a poly(caprolactone) diol, or a mixture thereof; preferably a PTMEG; more preferentially a PTMEG having a molecular weight of 400 to 2000 g/mol.

7. The composition as claimed in claim 1, wherein the polyol fraction also comprises a triol.

8. The composition as claimed in claim 1, wherein the polyisocyanate fraction also comprises an aliphatic diisocyanate, preferably chosen from pentamethylene diisocyanate (PMDI), hexamethylene diisocyanate (HDI), isophorone diisocyanate (IPDI), methylene dicyclohexyl diisocyanate (HMDI or hydrogenated MDI), or a mixture thereof; more preferentially IPDI.

9. The composition as claimed in claim 1, wherein the polyisocyanate fraction comprises at least 5 mol % relative to the —NCO functions, in particular at least 10 mol % relative to the —NCO functions, more particularly at least 15 mol % relative to the —NCO functions, of pentamethylene diisocyanate trimer.

10. The composition as claimed in claim 1, wherein the polyisocyanate fraction comprises:
1 to 40 mol %, preferably 2 to 30 mol %, relative to the —NCO functions of pentamethylene diisocyanate trimer; and
60 to 99 mol %, preferably 70 to 98 mol %, relative to the —NCO functions of aliphatic diisocyanate.

11. A process for producing a polyurethane coating on a substrate, comprising the following steps:
depositing on the substrate a layer of the composition as claimed in claim 1, then
crosslinking the composition.

12. A polyurethane coating which can be obtained by means of the process as defined in claim 11.
